(19) United States
(12) Patent Application Publication
(10) Pub. No.: US 2021/0206590 A1
(43) Pub. Date: Jul. 8, 2021

(54) IMAGING DEVICES

(71) Applicant: Hewlett-Packard Development Company, L.P., Houston, TX (US)

(72) Inventors: Alexander D Laws, Vancouver, WA (US); Robert L Winburne, Vancouver, WA (US); Benjamin M Coder, Vancouver, WA (US); Manlio Castillo, Corvallis, OR (US)

(21) Appl. No.: 16/065,342

(22) PCT Filed: Apr. 22, 2016
(86) PCT No.: PCT/US2016/028829

§ 371 Date: Jun. 22, 2018

(51) Int. Cl. B65H 3/06; B41J 11/00

(52) U.S. Cl. CPC B65H 3/0669; B41J 11/007

(57) ABSTRACT

In an example, a device may include a load stop system disposed on one side of a gear wall of an imaging device, adjacent to a media path, and a lift mechanism disposed on an opposite side of the gear wall, adjacent to the load stop system on the same side of the media path. The load stop system may block the media path in a first position, gather media in a second position, and may stow out of the media path in a third position. The load stop system may have a cam gear to drive the load stop system between the first, second, and third positions. The lift mechanism may rotate a picking system to lift away from an input area in a lifted position, and may lower towards the input area in a picking position. The lift mechanism may rotate adjacent to the cam gear.

### BACKGROUND

Imaging systems may print, scan, copy, or perform other actions with media. The imaging systems may scan the media for markings or patterns, deposit printing fluid, such as ink, or another printing substance, and/or may produce duplicates of the media, including markings or patterns thereon, in addition to other functions. Further, imaging systems may include feeding or picking systems to load the media and deliver or drive the media through the imaging system for performing operations on or with the media. Prior to being picked by the picking system, media may be loaded into an input area or tray of the imaging device, for use within the imaging device.

### BRIEF DESCRIPTION OF THE DRAWINGS

FIG. 1A is a perspective view of an example device.

FIG. 1B is an exploded view of an example device.

FIG. 1C is a perspective view of an example device.

FIG. 2A is a side view of an example imaging device.

FIG. 2B is a side view of an example imaging device.

FIG. 3A is a side view of an example imaging device.

FIG. 3B is a side view of an example imaging device.

FIG. 4A is a side view of an example imaging device.

FIG. 4B is a side view of an example imaging device.

FIG. 5 is a perspective view of an example imaging device.

### DETAILED DESCRIPTION

Imaging systems may include scanning systems, copying systems, printing or plotting systems, or other systems that perform actions or operations on or with media, sometimes referred to as print media. Imaging systems may deposit printing fluid, such as ink, or another printing substance, such as three-dimensional printing powder, on media or a target for media. Further, imaging systems may include feeding or picking systems to load the media and deliver or drive the media through a media path of the imaging system for performing operations on or with the media. Prior to being picked by the picking system, media, or a stack or ream thereof, may be loaded into an input area or input tray of the imaging device, for use within the imaging device.

In some situations, the media may be loaded too far into the input area, which may cause a jam or malfunction of internal components of the imaging device. Such a malfunction may prevent the imaging device from properly picking media from the input area and driving the media through the media path. Additionally, the media, in some situations, may be loaded into the input area in a disorderly fashion, causing inconsistencies in the orientation or disposition of the media in the input area. Such inconsistencies or incorrect orientation of the media may also cause a malfunction, thereby preventing the proper picking and driving of the media through the media path.

In some situations, the picking system may include pick rollers to pick and to deliver the media through the media path of the imaging system, after the media has been loaded into the input area. The pick rollers may exert a normal force on the media in order to create friction in between the pick rollers and the media, such that the rollers may pick the media. Such a normal force exerted by the pick rollers may make loading or refilling media into input area of the imaging system difficult, due to the friction in between the media and the pick rollers. Thus, it may be desirable in some situations to separate the pick system from the media loading area during loading or refilling operations. Separating the pick system from the loading area, or moving the pick system away from the loading area may make loading media into the imaging system easier by reducing or eliminating the friction or normal force between the pick system, or rollers therein, and the media being loaded into the imaging system.

In some situations, it may be desirable to provide an imaging device that may include a system to prevent media from being loaded too far into the media path or input area, and may also include a system to separate the picking system away from the input area. Further, it may be desirable for the imaging device to include a way to gather or organize the media within the input area or input tray such that the media is disposed consistently and properly within the input area so that the media may be properly picked and driven through the media path. Additionally, it may be desirable to then stow such a system out of the way of the media path, such that the picking system may be lowered into the input area and media may be picked and driven through the media path. Finally, it may be desirable for the two systems to both operate independently from one another, and to operate, at least partially, simultaneously to one another. The load stop system and the lift mechanism may also be disposed adjacent to one another such that the two systems occupy a relatively small and compact footprint within the imaging device.

Implementations of the present disclosure provide an imaging device having a load stop system and lift mechanism disposed in a compact fashion. Implementations of the imaging device may have the two systems operating partially simultaneously so as to prevent media from being loaded too far into an input area of the imaging device, gather the media within the input area, and then clear the media path while the lift mechanism may lower a picking system to the media to deliver the media through the media path. Such load stop systems and lift mechanisms may be compactly disposed adjacent to one another, and, in some implementations, may share structural and/or functional components to reduce power requirements and complexity.

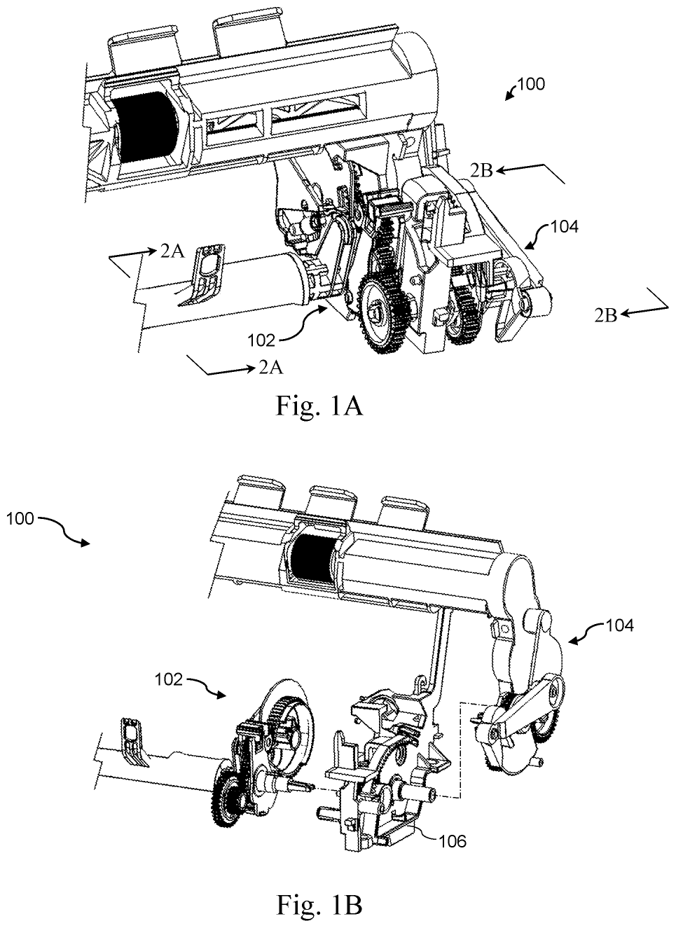

Referring now to FIG. 1A, perspective view of an example device 100 is illustrated. In some implementations, the example device 100 may be an imaging device. In further implementations, the device 100 may be a printer, scanner, copier, or other device to perform operations with or on media. The example device 100, in some implementations, may include a load stop system 102, and a lift mechanism 104. In some implementations, the load stop system 102 may block a media path in a first position, gather media in a second position, and to stow out of the media path in a third position. Additionally, the lift mechanism 104 may rotate a picking system to lift away from an input area in a lifted position, and to lower towards the input area in a picking position. The picking system may pick media and drive or deliver the media through the media path of the device 100 when disposed in the picking position. Referring additionally to FIG. 1B, an exploded view of an example device 100 is illustrated. The device 100 may further include a gear wall 106. In some implementations, the load stop system 102 may be disposed on one side, or a first side or inside side of the gear wall 106, and the lift mechanism 104 may be disposed on another side, or a second side or outside side, of the gear wall 106. In some implementations, the lift mechanism 104 may be disposed on an opposite side of the gear wall 106 from the load stop system 102.

Referring additionally to FIG. 1C, a perspective view of the device 100 is illustrated, wherein the device 100 is an imaging device 101. In some implementations, the load stop system 102 may be disposed adjacent to a media path, represented by arrow 105. In further implementations, the lift mechanism 104 may be disposed adjacent to the load stop system 102 on the same side of the media path 105. The imaging device 101 may receive media 108. In some implementations, the media 108 may be loaded or inserted into an input area 110. The media 108 may loaded in a direction similar to direction 103, for example. In some implementations, the load stop system 102 may stop the media 108 and prevent the media 108 from being loaded too far into the input area 110.

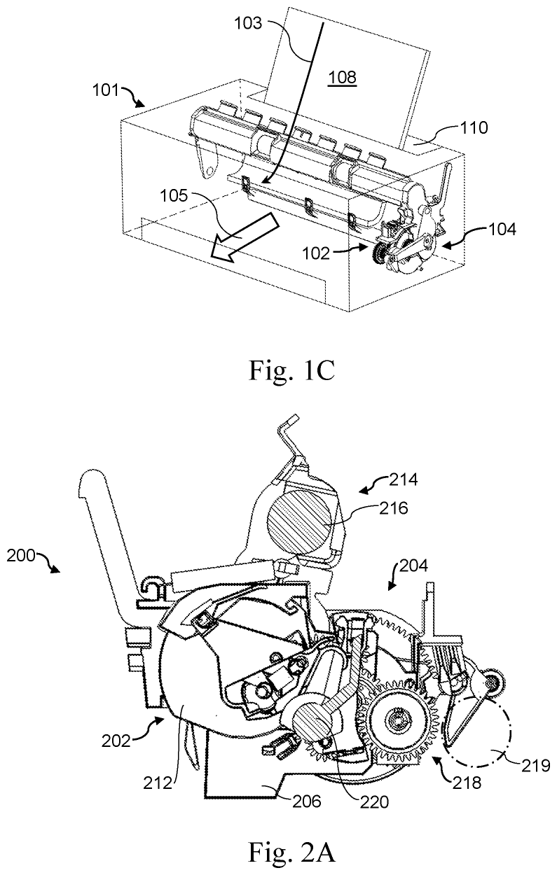

Referring now to FIG. 2A, an inside side view of an example imaging device 200 is illustrated. Example imaging device 200 may be similar to example device 100, or imaging device 101. Further, the similarly named elements of example imaging device 200 may be similar in function and/or structure to the elements of example device 100, or example imaging device 101, as they are described above. Example imaging device 200 may include a load stop system 202, and a lift mechanism 204. The load stop system 202 and the lift mechanism 204 may be engaged with a first and second side of a gear wall 206 of the imaging device, respectively. In some implementations, the gear wall 206 may be part of or engaged with a frame or a similar structure of the imaging device 200. In some implementations, the gear wall 206 may partially or wholly structurally support each of the load stop system 202 and the lift mechanism 204. The gear wall 206 may structurally support the load stop system 202 and the lift mechanism 204 adjacent to the media path. Further, in some implementations, the gear wall 206 may partially or wholly functionally support each of the load stop system 202 and the lift mechanism 204. In other words, the gear wall 206 may include structure or components that functionally engage with the two systems to enable their respective operation.

In some implementations, the load stop system 202 may include a stop paddle 220 that may be movable between a locked position, a gathering position, and a stowed position. FIG. 2A illustrates the stop paddle 220 disposed in the locked position, wherein the stop paddle 220 may extend, at least partially, into a media path of the imaging device such that the load stop system 202 blocks media from being inserted or loaded too far into the media path. Additionally, in some implementations, the imaging device 200 may include a transmission 218. The transmission 218 may be considered part of the load stop system 202, in some implementations, as part of the lift mechanism 204, in other implementations, or as a separate system or component in yet other implementations. The transmission 218, in some implementations, may be driven by a drive shaft or feed shaft 219, which may, in turn, be driven by a drive system of the imaging device 200. The feed shaft 219 may drive the transmission 218, which may, in turn, drive each of the load stop system 202 and the lift mechanism 204. In some implementations, the transmission may drive the load stop system 202 and the lifting system 204 independently from one another. In other implementations, the load stop system 202 and the lifting system 204 may be, at least partially, integrated with one another, or may share common components or elements. In further implementations, the transmission 218 may drive the load stop system 202 between the locked position, the gathering position, and the stowed position. The transmission 218, more specifically, may include a cam gear 212 to drive the stop paddle 220 between the locked, gathering, and stowed positions, in some implementations. In further implementations, the cam gear 212 may be considered part of the load stop system 202.

Referring additionally to FIG. 2B, an outside side view of the imaging system 200, and an example lift mechanism 204 therein, is illustrated. The imaging device 200 may further include a picking system 214. In some implementations, the picking system 214 may be considered as a part of the lift mechanism 204. In other implementations, the picking system 214 may be considered a separate system within the imaging device 200 that may work in conjunction with the lift mechanism 204. In further implementations, the picking system 214 may be structurally supported by the lift mechanism 204 and/or the gear wall 206 adjacent to the load stop system 202 and the media path. The picking system 214 may be a component or system of multiple components that may be able to pick media 208 from a media input area and deliver the media 208 through the imaging system 200, or into or through a media path thereof. The picking system 214 may include a pick roller 216, shown in FIG. 2A, in some implementations, to pick media 208 and deliver the media 208 through the imaging system 200, or a media path thereof. In some implementations, the picking system 214 may include multiple pick rollers 216.

In some implementations, the picking system 214, may be pivotable, movable, or rotatable about a picking center 207. The picking system 214 may be switchable about the picking center 207 between a lifted position, shown in FIG. 2B, and a picking position. The picking system 214, and/or pick rollers 216 thereof, may pick and deliver media 208 when the picking system 214 is disposed in the picking position, but not in the lifted position. Accordingly, when the picking system 214 is disposed in the lifted position, as illustrated in FIG. 2B, the picking system 214, and/or pick rollers 216 thereof, may be sufficiently spaced apart from the media input area, and media 208 therein, that the picking system does not pick media 208. Further, there may be sufficient space between the picking system 214, and/or pick rollers 216 thereof, and the input area that media 208 may be inserted or loaded into the input area without encountering resistance or obstruction from the picking system 214.

The lift mechanism 204 may be a component or system of multiple components that are able to transition the picking system 214 from the lifted position to the picking position, and vice versa, in some implementations. The lift mechanism 202 and the load stop system 204 may be timed to one another, such that the load stop system 202 is disposed in the stowed position, or third position, when the lift mechanism 204 completes the transition of the picking system 214 to the picking position. In some implementations, the lift mechanism 204 may include a linkage 222 to transition the picking system 214. In some implementations, the linkage 222 may be considered to be part of the transmission 218. In further implementations, the linkage 222 may rotate or pivot the picking system 214 adjacent to the cam gear 212. In further implementations, the lift mechanism 204 may lock the picking system when the picking system 214 is disposed in the lifted position, such that the picking system 204 may not lower to the picking position until the lift mechanism 204 unlocks the picking system 214. In further implementations, the lift mechanism 204 is to lock in position itself when the picking system is disposed in the lifted position. Further, the lift mechanism 204 may lock the picking system 214 in the lifted position when the load stop system 202 is disposed in the locked, or first, position.

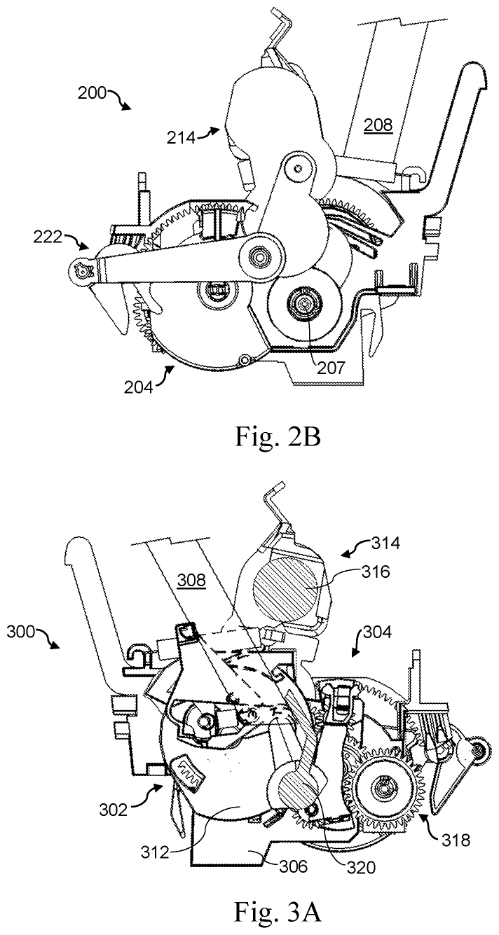

Referring now to FIG. 3A, an inside side view of an example imaging device 300 is illustrated. Example imaging device 300 may be similar to above-described devices or imaging devices. Further, the similarly named elements of example imaging device 300 may be similar in function and/or structure to the elements of the above-described devices or imaging devices. In some implementations, the imaging device 300, or other example devices or imaging devices, may be referred to as imaging systems. The imaging device 300 may include a load stop system 302 and a lift mechanism 304, as well as a gear wall 306, in some implementations. Further, the example imaging device 300 may include a picking system 314 having a pick roller 316, in some implementations. As illustrated in FIG. 3A, the load stop system 302, or a stop paddle 320 thereof, may be disposed in a gathering position, having been transitioned by a transmission 318 to the gathering position, from a locked position. The transmission 318, in some implementations, may be driven by a feed shaft and/or a drive system of the imaging device 300. The load stop system 302 may gather and organize media 308 disposed in an input area of the imaging device when in the gathering position.

Referring additionally to FIG. 3B, an outside side view of an example imaging device is illustrated. In some implementations, the illustrated state of the lift mechanism 304 in FIG. 3B may be the state that the system may be in when the load stop system 302 is in the gathering position. In some implementations, the lift mechanism 304, or the transmission 318 that may drive the lift mechanism 304, may comprise a swingarm 328. While the transmission 318 is driving the load stop system 302 to the gathering position, the transmission 318 may also, simultaneously, drive the swingarm 328, in some implementations. In further implementations, the swingarm 328, upon being driven by the transmission a sufficient amount, may drive a linkage 322 to transition the picking system 314 from the lifted position to the picking position. The swingarm 328 may engage with a ring gear 324, in some implementations, in order to drive the linkage 322 to transition the picking system 314. The ring gear 324 may be an array of teeth, or another type of engagement component, such as a friction surface, for example, and may be part of the gear wall 306, or may be a separate component, in some implementations. Further, in order to drive the linkage 322, the swingarm 328 may include a planetary gear with which the swingarm 328 engages with the ring gear 324. The state of the lift mechanism 304 illustrated in FIG. 3B may be that of a state wherein the swingarm 328 has yet to be driven a sufficient amount to actuate the linkage 322. As such, the picking system 314 may still be disposed in the lifted position when the load stop system 302 is in the gathering position. Accordingly, the picking system 314 may not pick and drive media 308 through a media path of the imaging device 300 while the load stop system 302 is disposed in the gathering position, or second position.

In some implementations, the picking system 314 may also include a gear train 326. The gear train 326 may be a component or system of components capable of transmitting motion from the transmission 318 to the pick roller 316. The gear train 326 may include gears, wheels, chain or belt drives, or other components capable of transmitting motion or torque. Once the picking system 314 is disposed in the picking position, the picking system 314 may drive the pick roller 316 with the gear train 326.

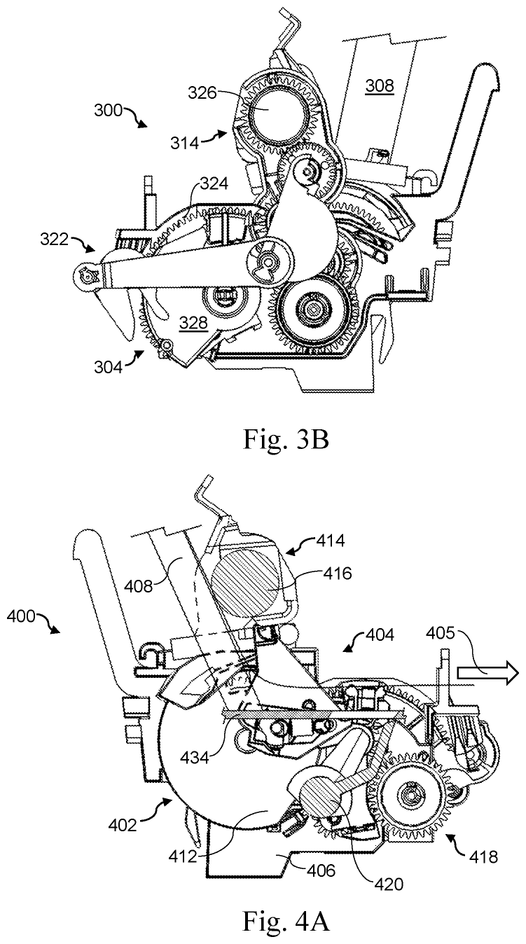

Referring now to FIG. 4A, an inside side view of an example imaging device 400 is illustrated. Example imaging device 400 may be similar to above-described devices or imaging devices. Further, the similarly named elements of example imaging device 400 may be similar in function and/or structure to the elements of the above-described devices or imaging devices. Imaging device 400 may include a load stop system 402, illustrated as disposed in a stowed position, or third position, in FIG. 4A. The load stop system 402 may be stowed out of the way of a media path 405 of the imaging device, when in the stowed position. In some implementations, a stop paddle 420 of the load stop system 402 may be stowed beneath or behind a separator plate 434 of a media input area of the imaging device 400, such that the stop paddle 420 does not obstruct the media path 405 when the load stop system 402 is disposed in the stowed position. In some implementations, the load stop system 402, or the stop paddle 420 thereof, may have transitioned to the stowed position from a gathering position. In order to transition the load stop system 402, a transmission 418 may have driven a cam gear 412 to rotate the stop paddle 420. In some implementations, the cam gear 412 may engage with an idler gear, not shown, in order to rotate the stop paddle 420. The idler gear may be engaged with or part of the gear wall 406. In some implementations, the transmission 418 may be driven by a feed shaft and/or drive system, not shown.

Referring additionally to FIG. 4B, an outside side view of the example imaging device 400 is illustrated. The imaging device 400 may further include a lift mechanism 404, which may be disposed on an opposite side of a gear wall 406 from the load stop system 402, in some implementations. The lift mechanism 404 may include or may be engaged with a picking system 414, in further implementations. As illustrated in FIGS. 4A-4B, the picking system 414 may be disposed in a picking position, wherein a pick roller 416 of the picking system 414 may pick media 408 and deliver the media 408 through the media path 405. In some implementations, the picking system 414 may have transitioned to the picking position from a lifted position. Similar to FIGS. 3A-3B, and the swingarm 328 described therein, a swingarm 428 may be driven by the transmission 418. In some implementations, the swingarm 428 may be driven along a ring gear 424. The swingarm 428, upon being driven a sufficient amount by the transmission 418, may actuate a linkage 422 in order to transition the picking system 418 to the picking position. The picking system 414 may rotate or pivot about a picking center 407, along a direction 409, to reach the picking position, in some implementations. In further implementations, the transmission 418 may drive the swingarm 428 simultaneously, or partially simultaneously as the load stop system 402. Further, the transmission 418, the load stop system 402, and the cam gear 412 therein, and the swingarm 428, may all be timed such that the swingarm 428 actuates the linkage 422 to transition the picking system 414 to the picking position when the load stop system 402, or the stop paddle 420 therein, reaches the stowed position, or third position. In other words, the picking system 414 may not be transitioned to the picking position and/or may not pick and drive media 408 through the media path 405 until the load stop system 402 no longer obstructs the media path 405.

Once the picking system 414 is fully transitioned to the picking position, the transmission 418, the drive system, or another component, may actuate the gear train 426 in order to cause the pick roller 416 to spin along example direction 411 to pick media 408 and drive the media 408 through the media path 405. In further implementations, once the imaging system 400 is finished performing actions on or with the media 408 that has been driven through the media path 405, the transmission 418 may further drive the load stop system 402 to a locked position, and further drive the lift mechanism 404 in reverse so that it transitions the picking system 414 from the picking position to the lifted position.

It should be noted that, while the transmission 418 is driving the load stop system 402, and/or the cam gear 412 and other components thereof, the transmission 418 may also be simultaneously driving the lift mechanism 404, or the swingarm 428 or other components thereof. Further, the load stop system 402 and the lift mechanism 404 and picking system 414 may be driven adjacently to one another to enable a compact orientation of the systems within the imaging system 400. More specifically, the cam gear 412 of the load stop system 402 may be driven directly adjacent to the picking center 407 of the picking system 414, in some implementations, and/or may be driven adjacent to the swingarm 428 of the lift mechanism 404 in further implementations. In other words, the load stop system 402 and the lift mechanism 404 may operate in parallel with one another, and also be oriented structurally parallel and/or adjacent to each other, laterally to the direction of the media path 405. This structural orientation may enable a compact layout of the imaging system 400, and further allow for the imaging system to occupy a relatively small volume.

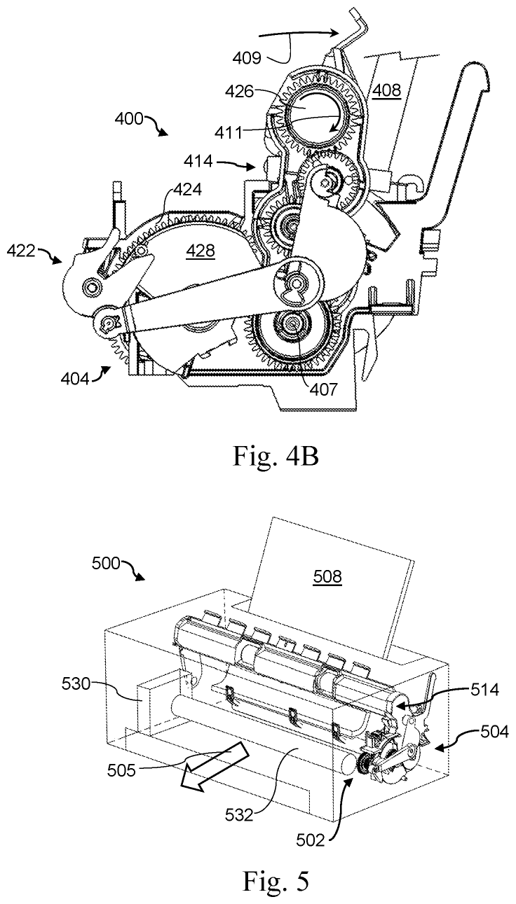

Referring now to FIG. 5, a perspective view of an example imaging device 500 is illustrated. Example imaging device 500 may be similar to above-described devices or imaging devices. Further, the similarly named elements of example imaging device 500 may be similar in function and/or structure to the elements of the above-described devices or imaging devices. Example imaging device 500 may include a load stop system 502, a lift mechanism 504, and a picking system 514, in some implementations. In further implementations, the imaging system 500 may also include a feed shaft 532 to drive the load stop system 502 and the lift mechanism 504. The feed shaft 532 may further drive the picking system 514, in some implementations. In yet further implementations, the feed shaft 532 may engage with a transmission of the imaging system in order to drive the load stop system 502, the lift mechanism 504, and/or the picking system 514. The imaging device 500 may further include a drive system 530, in some implementations. The drive system 530 may include a motive component or element, such as an electric motor, or other element capable of driving or turning the feed shaft 532. Additionally, the drive system 530 may include other components to alter, assist, or otherwise take part in driving the feed shaft 532. In some implementations, the drive system 530 may also include components for delivering or driving media 508 through a media path 505 of the imaging device 500. Such components may include rollers, belts, gears, wheels, or other components suitable for delivering media 508. The drive system 530, in some implementations, may drive or deliver the media 508 through the media path 505 after the picking system 514 picks media and delivers media into the media path 505.

The drive system 530 may be disposed on a first side of the media path 505, in some implementations. The load stop system 502, and/or the lift mechanism 504 may be disposed on a second side of the media path 505, opposite from the drive system 530. Further, the feed shaft 532 may extend across the media path 505 to engage with the load stop system 502 and the lift mechanism 504, in some implementations.

What is claimed is:

1. A device, comprising:
a load stop system disposed on one side of a gear wall of an imaging device, adjacent to a media path, the load stop system to block the media path in a first position, gather media in a second position, and to stow out of the media path in a third position, the load stop system having a cam gear to drive the load stop system between the first, second, and third positions; and
a lift mechanism disposed on an opposite side of the gear wall, adjacent to the load stop system on the same side of the media path, the lift mechanism to rotate a picking system to lift away from an input area in a lifted position, and to lower towards the input area in a picking position, the lift mechanism to rotate adjacent to the cam gear.

2. The device of claim 1, wherein the picking system is to pick media when the lift mechanism lowers the picking system to the picking position.

3. The device of claim 2, further comprising a feed shaft extending across the media path to drive the lift mechanism, the load stop system, and the picking system.

4. The device of claim 3, wherein the gear wall comprises a ring gear, the lift mechanism to engage with the ring gear to lift and lower the picking system.

5. The device of claim 4, wherein the lift mechanism is to lock in position when the picking system is disposed in the lifted position.

6. The device of claim 4, wherein the gear wall comprises an idler gear to drive the cam gear of the load stop system.

7. An imaging device, comprising:
a gear wall;
a load stop system disposed on a first side of the gear wall, comprising:
a transmission including a cam gear to drive the load stop system to block a media path in a first position, gather media in a second position, and to stow out of the media path in a third position;
a picking system to pick media from an input area and deliver media through the media path;
a lift mechanism disposed on a second side of the gear wall, the lift mechanism to rotate the picking system adjacent to the cam gear away from the input area to a lifted position, and to rotate the picking system towards the input area to a picking position when the load stop system is in the third position; and
a feed shaft extending across the media path, the feed shaft to drive the load stop system, the picking system, and the lift mechanism.

8. The imaging device of claim 7, wherein the feed shaft is to drive the lift mechanism and the load stop system simultaneously, such that the lift mechanism lowers the picking system to the picking position to pick media when the load stop system is disposed in the third position.

9. The imaging device of claim 8, further comprising a drive system to drive the feed shaft.

10. The imaging device of claim 8, wherein the gear wall structurally supports the lift mechanism, the picking system, and the load stop system adjacent to the media path.

11. A imaging system, comprising:
a frame having a gear wall;
a feed shaft extending across a media path;
a drive system disposed on a first side of the media path to drive media through the media path;
a load stop system disposed on a second side of the media path opposite from the drive system, and on an inside side of the gear wall, the load stop system to block the media path in a first position, gather media in a second position, and to stow out of the media path in a third position;
a lift mechanism disposed adjacent to the load stop system on an outside side of the gear wall, comprising a picking system and to lift the picking system away from an input area in a lifted position, and to lower the picking system towards the input area in a picking position when the load stop system is in the third position; and
a transmission, comprising;
a cam gear to drive the load stop system between the first, second, and third positions, and
a linkage to rotate the picking system adjacent to the cam gear between the lifted position and the picking position.

12. The imaging system of claim 11, wherein the picking system is to pick media from the input area and deliver the media through the media path when the load stop system is in the third position.

13. The imaging system of claim 12, wherein the feed shaft is to be driven by the drive system and is to drive the transmission.

14. The imaging system of claim 11, wherein the lift mechanism is to lock the picking system in the lifted position when the load stop system is disposed in the first position.

15. The imaging system of claim 11, wherein the imaging system is a printer.
